(19) United States
(12) Patent Application Publication
(10) Pub. No.: US 2025/0291521 A1
(43) Pub. Date: Sep. 18, 2025

(54) NON-TRANSITORY COMPUTER READABLE MEDIUM, INFORMATION PROCESSING SYSTEM, AND INFORMATION PROCESSING METHOD

(71) Applicant: FUJIFILM Business Innovation Corp., Tokyo (JP)

(72) Inventor: Masaru FUJII, Kanagawa (JP)

(73) Assignee: FUJIFILM Business Innovation Corp., Tokyo (JP)

(21) Appl. No.: 18/772,717

(22) Filed: Jul. 15, 2024

(30) Foreign Application Priority Data
Mar. 12, 2024 (JP) 2024-038432

(51) Int. Cl. G06F 3/12

(52) U.S. Cl. CPC G06F 3/1203; G06F 3/1226; G06F 3/126; G06F 3/1273; G06F 3/1286; G06F 3/1287; G06F 3/1288

(57) ABSTRACT

A non-transitory computer readable medium storing a program causing a computer to execute a process including associating a specific facility with an information device based on a combination of a usage period at which a usage person used the specific facility and a utilization period at which the usage person utilized the information device before the usage period and a predetermined determination criterion.

### CROSS-REFERENCE TO RELATED APPLICATIONS

This application is based on and claims priority under 35 USC 119 from Japanese Patent Application No. 2024-038432 filed Mar. 12, 2024.

### BACKGROUND

### (i) Technical Field

The present disclosure relates to a non-transitory computer readable medium, an information processing system, and an information processing method.

### (ii) Related Art

For example, Japanese Unexamined Patent Application Publication No. 2020-144763 discloses a system including a plurality of client terminals and a reception service system that receives data from the plurality of client terminals, in which the reception service system includes a first reception unit that receives data to be subjected to predetermined processing and a second reception unit that receives data not to be subjected to the predetermined processing.

### SUMMARY

Aspects of non-limiting embodiments of the present disclosure relate to providing a non-transitory computer readable medium and an information processing system that associate a specific facility with an information device.

Aspects of certain non-limiting exemplary embodiments of the present disclosure address the features discussed above and/or other features not described above. However, aspects of the non-limiting exemplary embodiments are not required to address the above features, and aspects of the non-limiting exemplary embodiments of the present disclosure may not address features described above.

According to an aspect of the present disclosure, there is provided a non-transitory computer readable medium storing a program causing a computer to execute a process including associating a specific facility with an information device based on a combination of a usage period at which a usage person used the specific facility and a utilization period at which the usage person utilized the information device before the usage period and a predetermined determination criterion.

### BRIEF DESCRIPTION OF THE DRAWINGS

Exemplary embodiments of the present disclosure will be described in detail based on the following figures, wherein:

FIG. 1 is a diagram illustrating an information output system according to an exemplary embodiment of the present disclosure;

FIG. 2 is a diagram illustrating a configuration of a cloud server according to the exemplary embodiment of the present disclosure;

FIG. 3 is a diagram illustrating an information processing system according to the exemplary embodiment of the present disclosure;

FIG. 4 is a diagram illustrating a procedure of associating a specific facility with an information device according to the exemplary embodiment of the present disclosure and is a diagram illustrating an example of positions of the specific facility and the information device;

FIG. 5 is a table illustrating MFP operation history data according to the exemplary embodiment of the present disclosure;

FIG. 6 is a table illustrating movement history data according to the exemplary embodiment of the present disclosure;

FIG. 7 is a table illustrating usage history data of the specific facility according to the exemplary embodiment of the present disclosure;

FIG. 8 is a flowchart illustrating a procedure of estimating the position of a usage person who operates the information device according to the exemplary embodiment of the present disclosure;

FIG. 9 is a table illustrating a position information list of the information device according to the exemplary embodiment of the present disclosure;

FIG. 10 is a flowchart illustrating a procedure of estimating the position of the information device according to the exemplary embodiment of the present disclosure;

FIG. 11 is a table illustrating a usage person attribute information table according to the exemplary embodiment of the present disclosure;

FIG. 12 is a table illustrating an attribute coefficient table according to the exemplary embodiment of the present disclosure;

FIG. 13A is a part of a flowchart illustrating a procedure of associating the specific facility with the information device according to the exemplary embodiment of the present disclosure;

FIG. 13B is a part of a flowchart illustrating a procedure of associating the specific facility with the information device according to the exemplary embodiment of the present disclosure, subsequent to FIG. 13A;

FIG. 14 is a table illustrating an elapsed time evaluation table according to the exemplary embodiment of the present disclosure;

FIG. 15 is a diagram illustrating a procedure of calculating a relevance evaluation table according to the exemplary embodiment of the present disclosure;

FIG. 16 is a table illustrating a calculation result of the relevance evaluation table according to the exemplary embodiment of the present disclosure;

FIG. 17 is a table illustrating an association result table according to the exemplary embodiment of the present disclosure; and

FIG. 18 is a flowchart illustrating a procedure of causing the associated information device to execute processing when the usage person who uses the specific facility uses the information device based on the association result obtained by the procedure of associating the specific facility with the information device according to the exemplary embodiment of the present disclosure.

### DETAILED DESCRIPTION

Hereinafter, an example of an exemplary embodiment of the present disclosure will be described with reference to the drawings. Note that in the drawings, the same or equivalent constituent elements and parts are denoted by the same reference signs. In addition, dimensional ratios in the drawings are exaggerated for convenience of description and may be different from actual ratios.

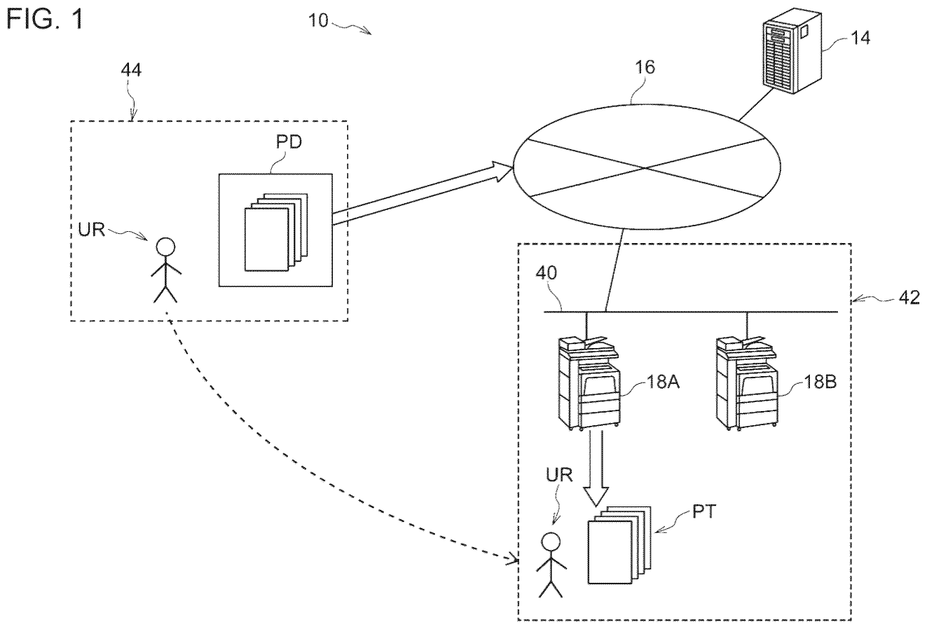

Note that in the following description and drawings, a reference sign with a number suffixed with one alphabet indicates that an equivalent component to a component corresponding to a reference sign indicated by the same number alone is distinguished. For example, “18A” and “18B” in FIG. 1 indicate that they are equivalent to the component indicated by “18”. Therefore, in order to distinguish a component denoted by one alphabet from an equivalent component, “first”, “second”, and the like may be added to the name of the component. In addition, in other words, the component corresponding to the reference sign to which one alphabet is attached is not limited to the illustrated component, and a plurality of components may exist.

Further, in the following description, “user” indicates a person who uses an information output system or an information processing system according to the present exemplary embodiment in some way without being limited to a specific person. That is, the described “user” also includes persons in different job positions, such as “executive” and “employee” and a person who uses only either the information output system or the information processing system.

### Exemplary Embodiment

FIG. 1 is an example of an information output system 10 according to the present exemplary embodiment. As described below, an overview of the information output system 10 and a preparation method thereof will be described.

### 1. Outline of Information Output System

As illustrated in FIG. 1, the information output system 10 according to the present exemplary embodiment includes a cloud server 14 connected to the Internet 16 and a multifunction printer (MFP) 18 which is an example of an information device. As illustrated in FIG. 1, a user UR uses the information output system 10 by communicating with the cloud server 14 via the Internet 16.

As an example, the MFP 18 is arranged at a first point 42 where a local network 40 is laid. Further, as illustrated in FIG. 1, the plurality of MFPs 18 is connected to the local network 40. The MFP 18 has a function of receiving a print job via the Internet 16 and forming an image on a document and a function of reading an image from a document as image data and transmitting the image to the cloud server 14. Note that in the following description, the MFP 18 may have any configuration as long as it can be connected to the cloud server 14 via the Internet 16, and it does not matter whether it is a device of the same type or a device of a different type.

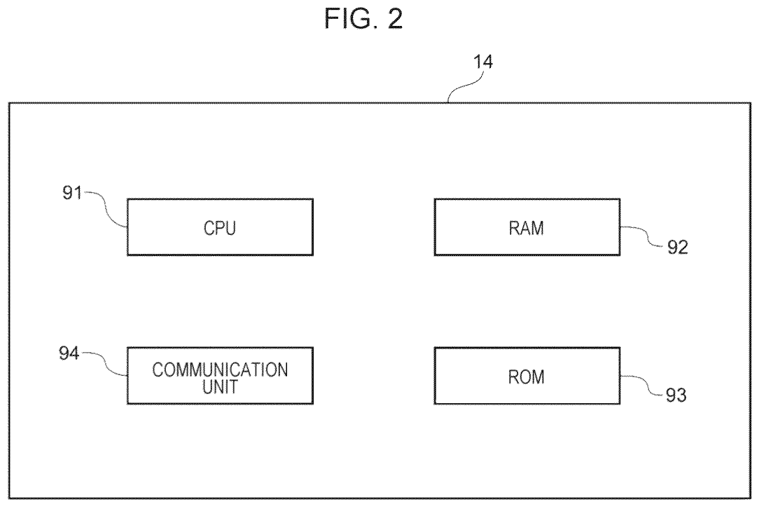

FIG. 2 is a block diagram illustrating a configuration of a main part of the cloud server 14 according to the present exemplary embodiment. Note that the cloud server 14 basically has the same configuration as a general computer.

The cloud server 14 includes a central processing unit (CPU) 91, a read only memory (ROM) 93, a random access memory (RAM) 92, a communication unit 94, etc.

The CPU 91 is a device that controls the entire operation of the cloud server 14 and is an example of a “processor” according to the present exemplary embodiment. Various control programs, various parameters, and the like, are previously stored in the ROM 93. The RAM 92 is used as a work area or the like when various programs are executed by the CPU 91. The communication unit 94 is connected to the Internet 16 (see FIG. 1) and performs various data transmission and reception with other devices such as a movement history recording unit 26, an operation history recording unit 28, a usage history recording unit 24, and the MFP 18 connected to the Internet 16. The units of the cloud server 14 are connected to each other by a bus (not illustrated).

When the CPU 91 accesses the ROM 93 and the RAM 92, the cloud server 14 executes processing in accordance with the contents of a program. Furthermore, the cloud server 14 executes control of communication data transmission and reception via the communication unit 94 by using the CPU 91. Note that the cloud server 14 may be connected to the Internet 16 in any manner as long as the cloud server 14 can communicate with the MFP 18.

Further, as illustrated in FIG. 1, the user UR is outside the range of the local network 40 at the first point 42 and is at a second point 44 that is a point apart from the first point 42, for example, a head office and a branch office, a permanent place and a business trip place, or the like. For the user UR at the second point 44, the first point 42 is a place where the presence or absence of an information device, the structure of a facility, and the like, cannot be known in detail.

Here, according to the present exemplary embodiment, the user UR transmits document data PD to the cloud server 14 from the second point 44 in order to use any one of the MFPs 18 provided at the first point 42. Subsequently, after transmitting the document data PD to the cloud server 14, the user UR moves from the second point 44 to the first point 42. Then, the user UR receives, at the first point 42, a printed material PT with the document data PD from a first MFP 18A, which is determined as the MFP 18 to which the document data PD is output, by the processing executed by the cloud server 14.

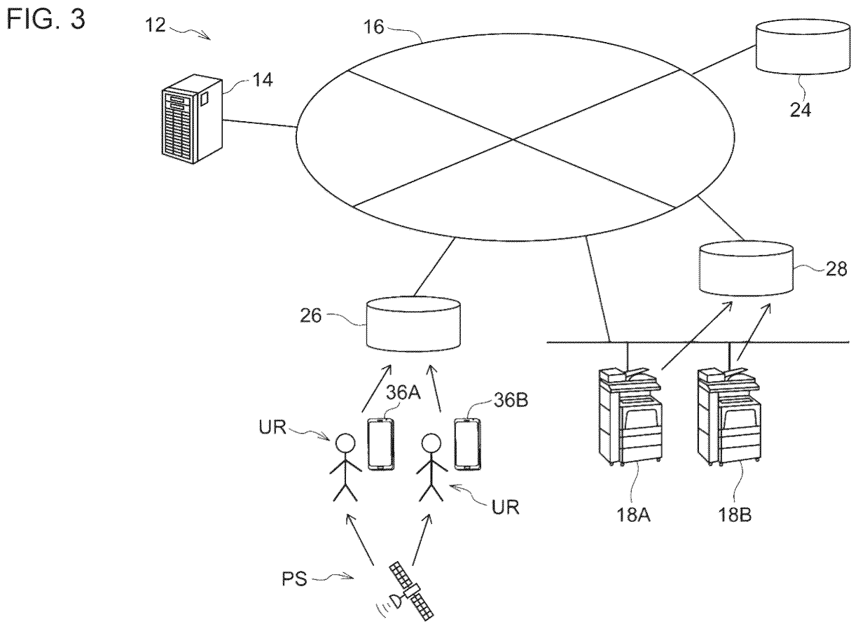

As described above, in the information output system 10 according to the present exemplary embodiment, the user UR does not specify the specific MFP 18, but the cloud server 14 executes processing to determine any one of the plurality of MFPs 18. Here, the method in which the information output system 10 according to the present exemplary embodiment determines any one of the MFPs 18, including a preparatory method therefor, will be described with reference to FIGS. 3 to 18 as appropriate.

### 2. Configuration of Information Processing System

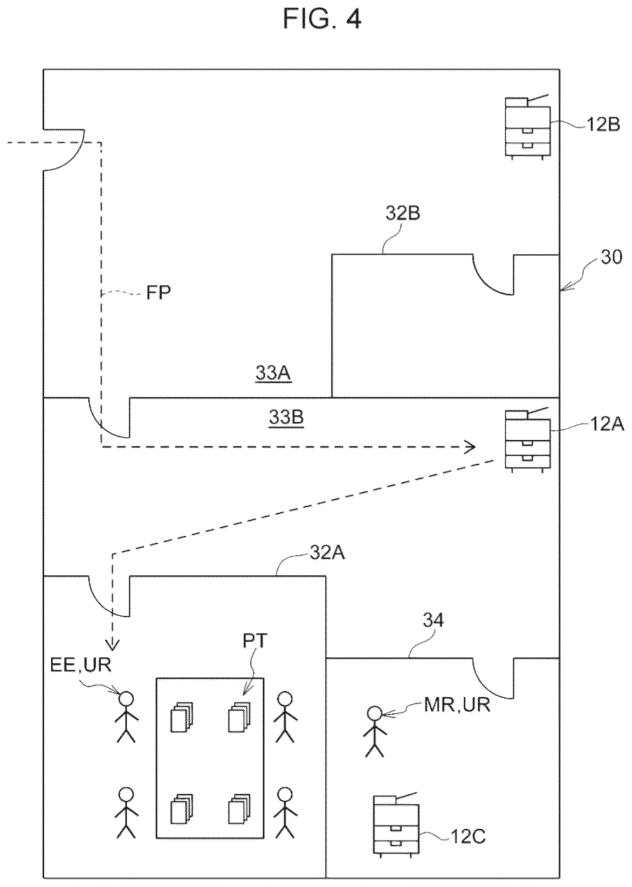

FIG. 3 is a diagram illustrating a configuration of an information processing system 12 according to the present exemplary embodiment, which implements the preparation method for the information output system 10. Further, FIG. 4 is a diagram illustrating an example of positions of a specific facility and an information device according to the present exemplary embodiment. The “specific facility” described according to the present exemplary embodiment is, as an example, a first meeting room 32A forming a section of the inside of a building 30.

As illustrated in FIG. 4, inside the building 30, a first living room 33A, a second living room 33B, the first meeting room 32A, a second meeting room 32B, and an executive room 34 are partitioned by walls. The plurality of the MFPs 18 is provided away from each other. As illustrated in FIG. 4, the first meeting room 32A is larger than the second meeting room 32B, and therefore the utilization frequency of the first meeting room 32A is higher than that of the second meeting room 32B. Therefore, as indicated by a footprint FP, the user UR who uses the first meeting room 32A prints a document in the first MFP 18A and then enters the first meeting room 32A with the printed material PT. Note that as illustrated in FIG. 4, a second MFP 18B is provided near the second meeting room 32B, but is far from the first meeting room 32A, and therefore is less frequently utilized by the user UR who utilizes the first meeting room 32A.

The executive room 34 is adjacent to the first meeting room 32A with a wall interposed therebetween, and an executive MR permanently stays in the executive room 34. A third MFP 18C is provided inside the executive room 34. Therefore, the third MFP 18C is a device exclusively utilized by the executive MR among the users UR who use the building 30.

As illustrated in FIG. 3, the information processing system 12 according to the present exemplary embodiment collects position information PI of the user UR having a portable device 36. As illustrated in FIG. 3, the information processing system 12 is connected to the usage history recording unit 24, the operation history recording unit 28, and the movement history recording unit 26 via the Internet 16.

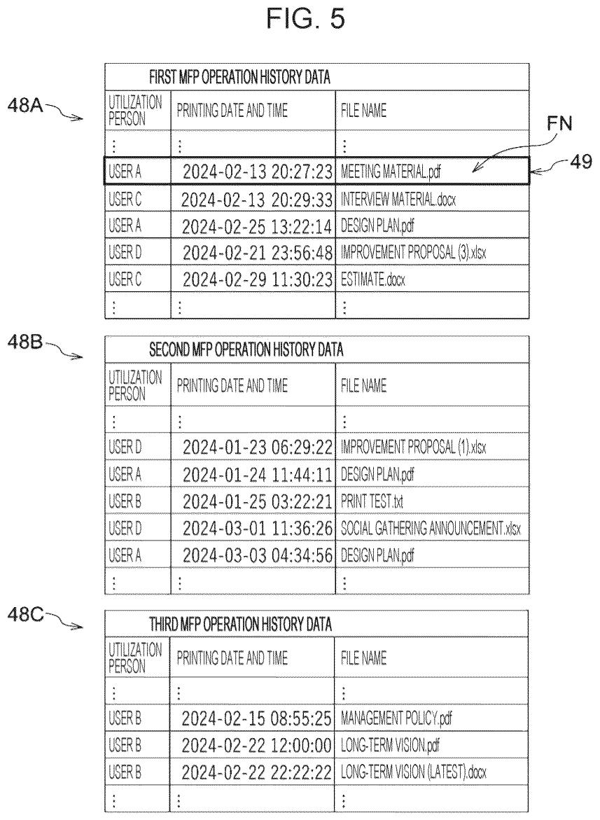

The operation history recording unit 28 records the history of using each of the MFPs 18 with regard to the MFP 18 used by any person. More specifically, as illustrated in FIG. 5, the operation history recording unit 28 records MFP operation history data 48 for each of the MFPs 18. Furthermore, as illustrated in FIG. 5 as an example, the MFP operation history data 48 records “utilization person” indicating the user UR who utilized the MFP 18, “printing date and time” indicating the date and time when the MFP 18 was utilized, and “file name” that is an example of identification information of printed data. Note that the “printing date and time” indicating the date and time when the MFP 18 was utilized is an example of a “utilization period” according to the present exemplary embodiment. Furthermore, as illustrated in FIG. 5, an added record 49 is recorded in the MFP operation history data 48 every time the MFP 18 is used. That is, each of the records 49 is an example of a “utilization history” according to the present exemplary embodiment.

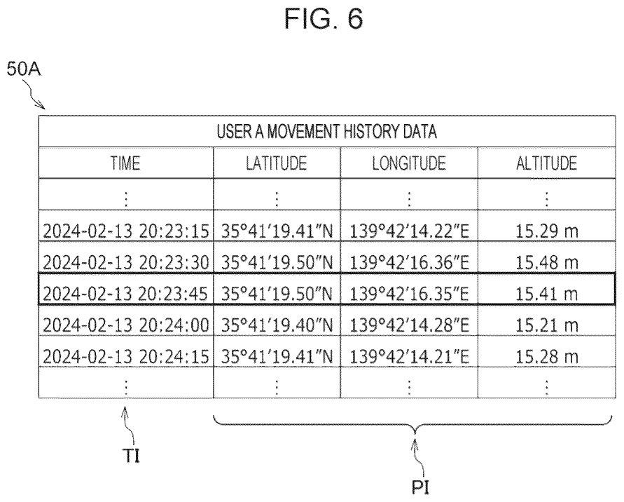

As illustrated in FIG. 3, the movement history recording unit 26 records the position information PI of the user UR who moves while carrying the portable device 36. More specifically, as illustrated in FIG. 6, the movement history recording unit 26 records the position information PI of the portable device 36 as movement history data 50. The movement history data 50 records, as an example, the coordinates of “latitude”, “longitude”, and “altitude”, which are the position information PI of the portable device 36, and “time”, which is the period when the position information PI is acquired.

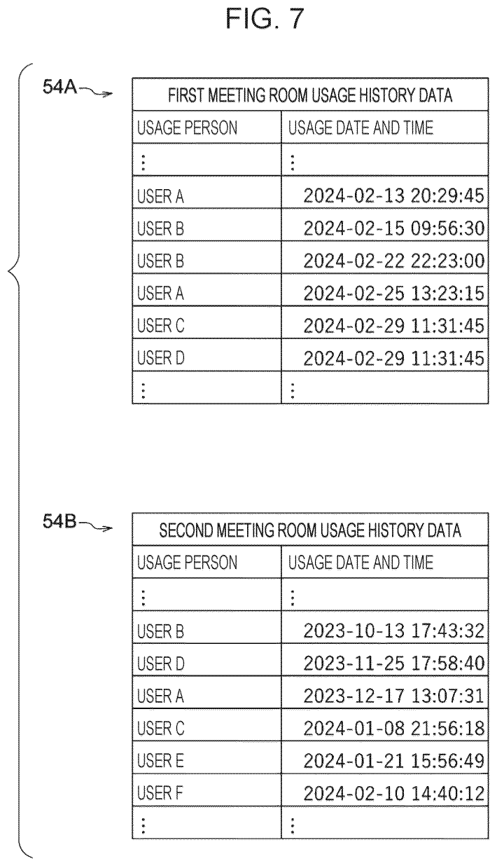

As illustrated in FIG. 7, the usage history recording unit 24 records the usage date and time of the person who used the meeting room 32. More specifically, as illustrated in FIG. 7, the usage history recording unit 24 records the usage history for each of the meeting rooms 32 as usage history data 54. The usage history data 54 recodes, for example, the “usage person” who is a person who used the meeting room 32 and the date and time when the meeting room 32 was used. Furthermore, as illustrated in FIG. 7, the usage history data 54 records a record 49 that is added each time the meeting room 32 is used. As long as the usage history data 54 records the time at which the user UR was in the meeting room 32, the method for recording the usage history data 54 is not particularly limited, but for example, the date and time at which the electronic lock of the meeting room 32 is released when the user UR uses the meeting room 32 is recorded. In other words, the electronic lock creates the usage history data 54 in which the user UR used the meeting room 32.

### 3. Method of Estimating Installation Position of MFP

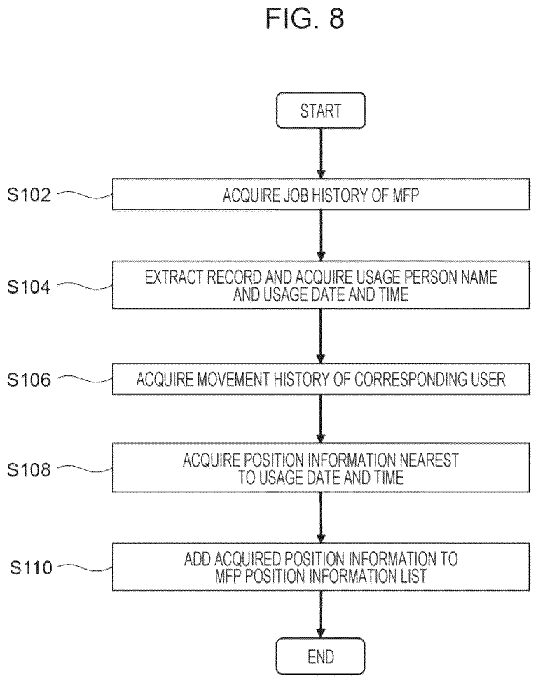

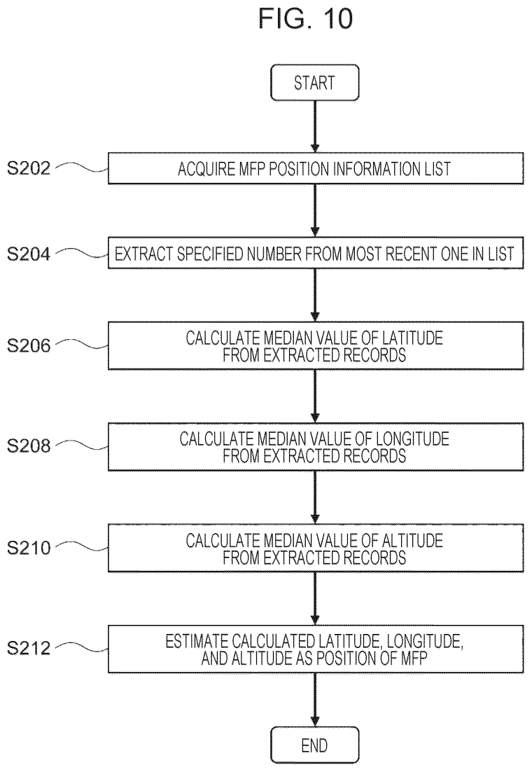

Next, the method by which the CPU 91 of the cloud server 14 according to the present exemplary embodiment estimates the installation position of the MFP 18 will be described with reference to FIGS. 8 to 10. As illustrated in FIGS. 8 and 10, the cloud server 14 according to the present exemplary embodiment executes a procedure of acquiring the position information that can be estimated as the position information of the MFP and a procedure of estimating the installation position of the MFP from a plurality of pieces of position information.

(Procedure of Acquiring Position Information that can be Estimated as Position Information of MFP)

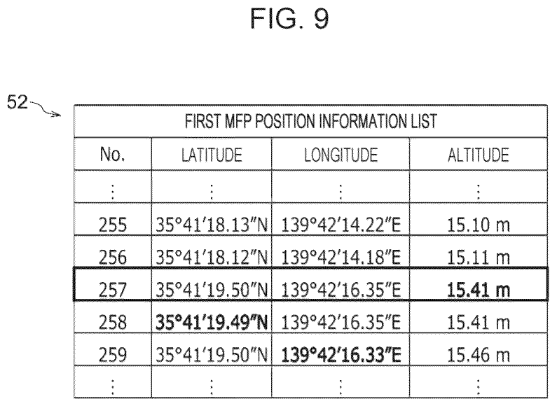

FIG. 8 illustrates, as processing executed by the CPU 91 according to the present exemplary embodiment, a procedure of acquiring the position information that can be estimated as the position information of the MFP based on the MFP operation history data 48 of the MFP 18 and the movement history data 50 of the user UR. In FIG. 9, the position information PI of the MFP 18 estimated based on the movement history data 50 is recorded as an MFP position information list 52. Note that as illustrated in FIG. 9, in the MFP position information list 52 of the MFP 18, the position information PI estimated as the actual position of each of the MFPs is recorded as a record. In addition, the MFP position information list 52 of the MFP 18 is recorded for each of the MFPs 18. Here, as an example, the process of generating a record (the record of No. 257) surrounded by a thick frame in FIG. 9 will be described.

First, in step S102, the CPU 91 acquires a job history of the MFP 18. More specifically, the CPU 91 acquires the MFP operation history data 48 of any one of the MFPs 18 illustrated in FIG. 5 from the operation history recording unit 28. Here, as illustrated in FIG. 5 as an example, the CPU 91 acquires first MFP operation history data 48A that is the operation history of the first MFP 18A. Then, the CPU 91 proceeds to step S104.

Subsequently, in step S104, the CPU 91 extracts the record 49 included in the job history of the MFP 18 acquired in step S102 and acquires the usage person name and the usage date and time included in the record 49. Here, as illustrated in FIG. 5, the CPU 91 extracts the record 49 surrounded by the thick frame from among the records 49 included in the MFP operation history data 48 and acquires that the utilization person name is “user A” and the printing date and time is “2024-02-13 20:27:23”. Then, the CPU 91 proceeds to step S106.

Subsequently, in step S106, the CPU 91 acquires the movement history of the user UR acquired in step S104 from the movement history recording unit 26. More specifically, the CPU 91 acquires, from the movement history recording unit 26, the movement history data 50 corresponding to the name of the user UR acquired in step S104. Here, as illustrated in FIG. 6, the CPU 91 acquires the movement history data 50 of the “user A” from the movement history recording unit 26. Then, the CPU 91 proceeds to step S108.

Subsequently, in step S108, the CPU 91 acquires the position information PI nearest to the usage date and time among the acquired movement history data 50. More specifically, the CPU 91 acquires, from among the records 49 included in the movement history data 50, the record 49 at the time nearest to the usage date and time acquired in step S104. Here, as illustrated in FIG. 6, the CPU 91 extracts the record 49 that is surrounded by the thick frame and includes the value “2024-02-13 20:23:45”, which is nearest to the time acquired in step S104, in the movement history data 50. Furthermore, the CPU 91 acquires, as the position information PI, the latitudes, the longitudes, and the altitudes that are the positions of the user A in the record 49. Then, the CPU 91 proceeds to step S110.

Subsequently, in step S110, the CPU 91 adds the acquired position information PI of the user UR to the MFP position information list 52 as illustrated in FIG. 9. More specifically, the CPU 91 adds the position, longitude, and altitude acquired in step S108 to the MFP position information list 52. Here, as illustrated in FIG. 9, the CPU 91 adds the position information PI of the user A acquired in step S108 as the record surrounded by the thick frame in the MFP position information list 52 of the first MFP 18A selected in step S102.

In the above-described procedure, the CPU 91 acquires the position information PI that can be estimated as the position information PI of the MFP 18 and creates the MFP position information list 52 of the MFP 18. Note that the created MFP position information list 52 is recorded in the ROM 93 of the cloud server 14, as an example.

Note that the procedure of acquiring the position information that can be estimated as the position information of the MFP in the present description is executed not only once but also for the number of records included in the MFP operation history data 48. Furthermore, the procedure of acquiring the position information that can be estimated as the position information of the MFP in the present description is executed not only once but also for each of the MFPs 18 whose MFP operation history data 48 is included in the operation history recording unit 28.

(Procedure of Estimating Installation Position of MFP from Plurality of Pieces of Position Information)

FIG. 10 illustrates, as processing executed by the CPU 91 according to the present exemplary embodiment, the procedure of estimating the installation position of the MFP from a plurality of pieces of position information. Note that here, an example will be described in which the process is executed in a state where a plurality of records is recorded in the MFP position information list 52.

First, in step S202, the CPU 91 acquires the MFP position information list 52 of the MFP 18. More specifically, the CPU 91 acquires, from the ROM 93, the MFP position information list 52 of the MFP 18 recorded in step S110. Then, the CPU 91 proceeds to step S204.

Subsequently, in step S204, the CPU 91 extracts the specified number of records as a predetermined number from the MFP position information list 52 of the MFP 18. More specifically, the CPU 91 extracts, from the position information PI logs, a plurality of records having new recording dates and times (the records having large No. values). Then, the CPU 91 proceeds to step S206.

Subsequently, in step S206, the CPU 91 calculates the median value of the latitude from the records extracted in step S204. More specifically, the CPU 91 acquires the latitude for each of the records extracted in step S204 and calculates the median value when the values of the acquired latitudes are arranged in order. For example, when the records of No. 255 to No. 259 in FIG. 9 are extracted, “35° 41′19.49″N” of No. 258 in FIG. 9 is calculated. Then, the CPU 91 proceeds to step S208.

Subsequently, in step S208, the CPU 91 calculates the median value of the longitude from the records extracted in step S204. More specifically, the CPU 91 acquires the longitude for each of the records extracted in step S204 and calculates the median value when the values of the acquired longitudes are arranged in order. For example, when the records of No. 255 to No. 259 in FIG. 9 are extracted, “139°42′16.33″E” of No. 259 in FIG. 9 is calculated. Then, the CPU 91 proceeds to step S210.

Subsequently, in step S210, the CPU 91 calculates the median value of the altitude from the records extracted in step S204. More specifically, the CPU 91 acquires the altitude for each of the records extracted in step S204 and calculates the median value when the values of the acquired altitudes are arranged in order. For example, when the records of No. 255 to No. 259 in FIG. 9 are extracted, “15.41 m” of No. 257 in FIG. 9 is calculated. Then, the CPU 91 proceeds to step S212.

Subsequently, in step S212, the CPU 91 estimates the latitude, longitude, and altitude calculated from step S206 to step S210 as the position of the MFP 18. More specifically, the CPU 91 estimates the position indicated by “35° 41′19.50″N”, “139°42′16.33″E”, and “15.41 m” calculated in the respective procedures described above as the installation position of the first MFP 18A.

In this way, the CPU 91 estimates the installation position of the MFP 18 from the plurality of pieces of position information PI. Note that in the above-described procedure, the example in which the CPU 91 estimates the installation position of the first MFP 18A has been described, but the installation positions of the other MFPs 18 are also estimated in a similar manner. Furthermore, the estimated installation position of the MFP 18 is recorded in the ROM 93 of the cloud server 14 as an example.

Although the installation position of the MFP 18 as an example of the information device has been described in the above-described procedure, the target for which the position information PI is acquired is not limited to MFPs. That is, the position information PI of the meeting room 32 may be estimated in the same manner based on the usage history data 54 of the meeting room 32 illustrated in FIG. 7 and the movement history data 50 illustrated in FIG. 6. In other words, in the meeting room 32 illustrated in FIG. 4, a device (the electronic lock in the example of the above description) that creates the usage history data 54 of the meeting room 32 is also an example of the information device according to the present exemplary embodiment. The target for which the position information PI is acquired may be similarly executed for the meeting room. That is, the target for which the position information PI is acquired is not limited to the information device.

In the above-described method for estimating the installation position of the MFP 18, the timing at which the CPU 91 executes the procedure is not particularly limited. Examples include a case where the CPU 91 executes the procedure on a regular basis or at a timing when it is determined that the MFP 18 has been added to the network.

As the case of execution on a regular basis, for example, a case is assumed where the CPU 91 estimates the installation position of the MFP 18 in a period of the same date every month. In addition, as the case of execution at the timing when it is determined that the MFP 18 has been added to the network, for example, a case is assumed where the CPU 91 estimates the installation position of the MFP 18 at the timing when it is determined that the connection has been established between the new MFP 18 and the network. Similarly, a case is assumed where the installation position of the MFP 18 is estimated when it is determined that the connection with the network has been established again after the MFP 18 was disconnected from the network once. By execution at these timings, for example, even when the installation position of the MFP 18 is changed, the CPU 91 executes the procedure on a regular basis to estimate the changed installation position of the MFP 18.

Although the estimation of the installation position of the MFP 18 is executed based on the MFP position information list 52 in the description above, the operation of the CPU 91 according to the present exemplary embodiment is not limited thereto. For example, when the CPU 91 determines that the user UR has operated the MFP 18 to execute a print job, the CPU 91 may determine the installation position of the MFP 18 based on the position information PI of the portable device 36 carried by the utilization person who operated the MFP 18.

4. Association Between Meeting Room with MFP.

Furthermore, as illustrated in FIG. 4, when the meeting room 32 is used and the printed material PT is created from the MFP 18, the MFP 18, which executes the print job, is preferably associated with the meeting room 32. For example, in the example of FIG. 4, when the user UR who uses the meeting room 32 is not an executive, it is difficult for the user UR to create the printed material PT by using the third MFP 18C provided inside the executive room 34.

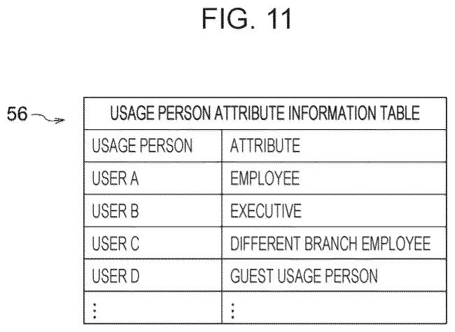

Here, the CPU 91 of the information processing system 12 according to the present exemplary embodiment associates the meeting room 32 with the installation position of the MFP 18 estimated in the process described above. The procedure for associating the meeting room 32 with the MFP 18 will be described with reference to FIGS. 11 to 17.

### (Setting Similarity of Attribute of Usage Person)

FIG. 11 illustrates a usage person attribute information table 56 in which the name of the user UR who utilizes the MFP 18 and the attribute of the user UR are associated with each other according to the present exemplary embodiment. In the usage person attribute information table 56, the name of the usage person and the attributes (including job title and the like) of the usage person are recorded in association with each other. That is, “employee” and “executive” are examples of the attribute of the usage person according to the present exemplary embodiment. Further, the usage person attribute information table 56 is recorded in the ROM 93 of the cloud server 14 as an example.

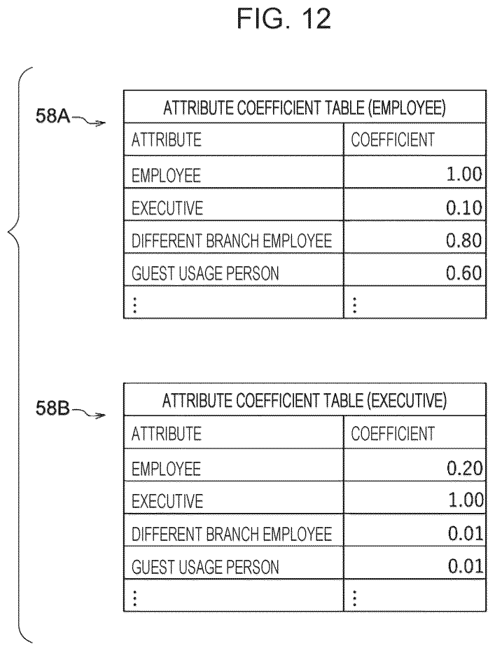

FIG. 12 illustrates an attribute coefficient table 58 in which the attribute of the user UR who utilizes the MFP 18 is associated with the similarity (closeness) of the attributes of the others according to the present exemplary embodiment. For example, in a first attribute coefficient table 58A, the degree of similarity of another attribute to the attribute “employee” is recorded as a coefficient. For example, FIG. 12 illustrates, as an example, that, since “employee” and “executive” have different positions, the coefficient of “executive” is set to be small. That is, according to the present exemplary embodiment, the relationship between the attribute and the coefficient combined in the attribute coefficient table 58 is an example of the degree of relevance according to the present exemplary embodiment. As an example, the usage person attribute information table 56 is recorded in the ROM 93 of the cloud server 14.

As illustrated in FIG. 12, the similarity of one attribute to the other attribute does not need to be the same. The reason for this will be described below.

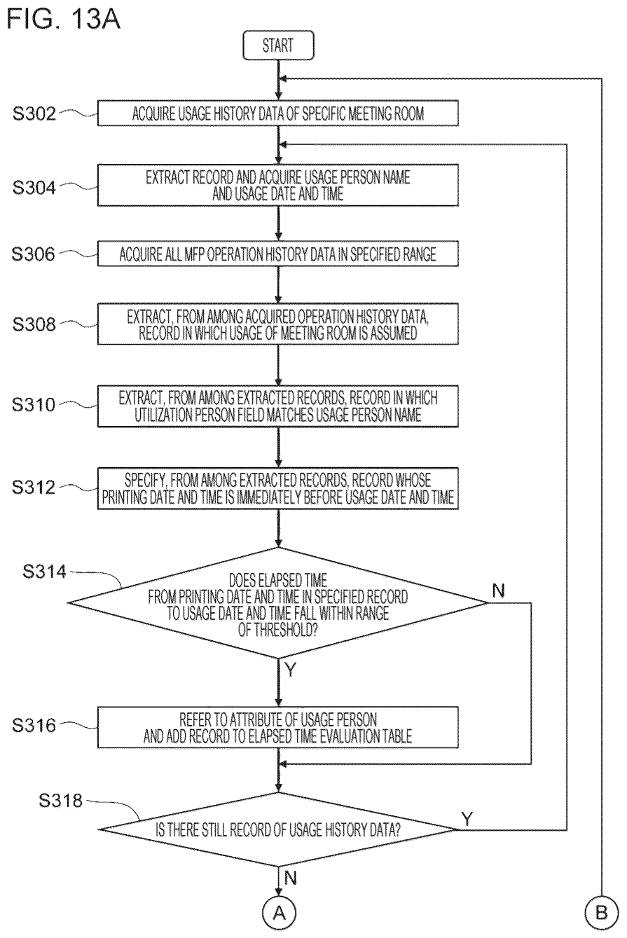

Next, the method by which the CPU 91 according to the present exemplary embodiment associates the MFP 18 with the meeting room 32 will be described with reference to FIGS. 13A to 17. The CPU 91 according to the present exemplary embodiment executes the procedure of associating the MFP with the meeting room based on the utilization period at which the MFP 18 was utilized and the usage period at which the meeting room 32 was used.

(Procedure of Associating MFP with Meeting Room)

FIGS. 13A and 13B illustrate the procedure by which the CPU 91 according to the present exemplary embodiment associates the MFP 18 with the meeting room 32 based on the utilization period at which the MFP 18 was utilized and the usage period at which the meeting room 32 was used. In this description, it is assumed that the utilization period of the MFP 18 and the usage period of the meeting room 32 are equivalent to those illustrated in FIGS. 5 and 7. Furthermore, according to the present exemplary embodiment, it is assumed that the specific position of the meeting room 32 is estimated by applying the procedure of acquiring the position information that can be estimated as the position information of the MFP and the procedure of estimating the installation position of the MFP from the plurality of pieces of position information in the description above.

First, in step S302, the CPU 91 acquires the usage history data 54 of the specific meeting room 32. More specifically, the CPU 91 acquires the MFP operation history data 48 of any one of the meeting rooms 32 illustrated in FIG. 7 from the usage history recording unit 24. Here, as illustrated in FIG. 7 as an example, the CPU 91 acquires first usage history data 54A that is the usage history of the first meeting room 32A. Then, the CPU 91 proceeds to step S304.

Subsequently, in step S304, the CPU 91 extracts a record included in the usage history of the meeting room 32 acquired in step S302 and acquires the usage person name and the usage date and time included in the record. Here, as illustrated in FIG. 7, the CPU 91 extracts the record surrounded by the thick frame from among the records included in the first usage history data 54A and acquires that the usage person name is the “user A” and the usage date and time is “2024-02-13 20:29:45”. Further, according to the present exemplary embodiment, the usage date and time in the usage history data 54 is an example of the “usage period” according to the present exemplary embodiment. Then, the CPU 91 proceeds to step S306.

Subsequently, in step S306, the CPU 91 acquires all the MFP operation history data 48 of the MFP 18 located in a specified range from the meeting room 32 specified in step S302. The specified range may be set in any manner as long as the specified range includes a range which is considered to be utilized by the user UR who uses the meeting room 32, such as a distance with respect to the position information PI of the meeting room 32, that is, the latitude, the longitude, and the altitude of the meeting room 32. Here, the specified range is determined based on the distances to the latitude and longitude of the meeting room 32 so as to include the first MFP 18A, the second MFP 18B, and the third MFP 18C. Thus, as illustrated in FIG. 5, the CPU 91 acquires the MFP operation history data 48 of the first MFP 18A, the second MFP 18B, and the third MFP 18C from the operation history recording unit 28. Then, the CPU 91 proceeds to step S308.

Subsequently, in step S308, the CPU 91 extracts, from among the acquired MFP operation history data 48, the record 49 in which the usage of the meeting room 32 is assumed. Specifically, based on a file name FN included in the MFP operation history data 48, the CPU 91 extracts the record 49 in which the usage of the meeting room 32 is assumed. Then, the CPU 91 proceeds to step S310.

Subsequently, in step S310, the CPU 91 further extracts, from among the extracted records 49, the record 49 in which the utilization person name matches the usage person name. More specifically, the CPU 91 extracts, from among the records 49 extracted in step S308, the record 49 that matches the usage person name with the “user A” acquired in step S304. Then, the CPU 91 proceeds to step S312.

Subsequently, in step S312, the CPU 91 further specifies, from among the acquired records 49, the record 49 whose printing date and time is immediately before the usage date and time. More specifically, the CPU 91 specifies, among the records 49 extracted in step S310, the record 49 whose printing date and time is immediately before “2024-02-13 20:29:45” acquired in step S304. With this procedure, here, the record 49 surrounded by the thick frame illustrated in FIG. 5 is extracted. Then, the CPU 91 proceeds to step S314.

Subsequently, in step S314, the CPU 91 determines whether the elapsed time from the printing date and time in the specified record 49 to the usage date and time falls within the range of a threshold. More specifically, the CPU 91 calculates the time elapsed from the printing date and time of the record 49 specified in step S312 to the usage date and time of the record 49 extracted in step S304. Here, it is calculated as 142 seconds. When the CPU 91 makes a positive determination in step S314, the process proceeds to step S316. Conversely, when the CPU 91 makes a negative determination in step S314, the process proceeds to step S318.

Further, the threshold for the elapsed time is appropriately set based on an expected elapsed time from printing to usage of the meeting room 32. For example, in a case where the distance from the MFP 18 to the meeting room 32 is long, the elapsed time is expected to be long, and thus the threshold is set to be large, and in a case where the distance from the MFP 18 to the meeting room 32 is short, the elapsed time is expected to be short, and thus the threshold is set to be small.

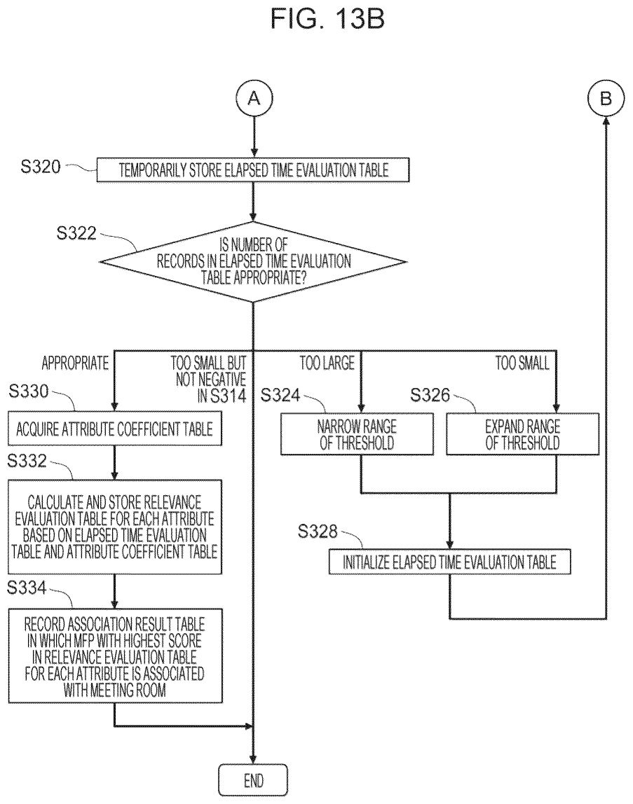

Subsequently, in step S316, the CPU 91 refers to the attribute of the usage person and then adds the record to an elapsed time evaluation table 60. More specifically, the CPU 91 refers to the usage person attribute information table 56 and thus acquires “employee” as the attribute of the “user A” who is the usage person acquired in step S304. Then, as illustrated in FIG. 14, the CPU 91 adds the elapsed time calculated in step S314 to the record of the elapsed time evaluation table 60 together with the attribute of the usage person and the name of the MFP 18. Then, the CPU 91 proceeds to step S318.

Subsequently, in step S318, the CPU 91 determines whether there is a usage history record that has not been extracted in step S304. Then, when the CPU 91 makes a positive determination in step S318, the process proceeds to step S304. Conversely, when the CPU 91 makes a negative determination in step S318, the process proceeds to step S320.

Subsequently, in step S320, the CPU 91 temporarily stores the elapsed time evaluation table 60 created up to step S318 in the RAM 92. More specifically, as illustrated in FIG. 14, the CPU 91 temporarily stores, in the RAM 92, the elapsed time evaluation table 60 having a plurality of records. Then, the process proceeds to step S322 by the CPU 91.

Subsequently, in Step S322, the CPU 91 determines the number of records included in the elapsed time evaluation table 60 created up to Step S318. When the CPU 91 determines that the number of records included in the elapsed time evaluation table 60 is appropriate, the process proceeds to step S330. Further, when the CPU 91 determines that the number of records included in the elapsed time evaluation table 60 is too large, the process proceeds to step S324. Furthermore, when the CPU 91 determines that the number of records included in the elapsed time evaluation table 60 is too small, the process proceeds to step S326. When the CPU 91 determines that the number of records included in the elapsed time evaluation table 60 is too small and determines that a negative determination has not been made even once in step S314, the procedure of associating the MFP 18 with the meeting room 32 ends.

Subsequently, in Step S324, the CPU 91 narrows the range of the threshold for the elapsed time from the printing date and time to the usage date and time. More specifically, the CPU 91 narrows the range of the threshold referred to in step S314 to increase the frequency of a negative determination in step S314. Then, the CPU 91 proceeds to step S328.

Subsequently, in step S328, the CPU 91 initializes the elapsed time table temporarily stored in step S320. In other words, the CPU 91 deletes all the records added in step S320. Then, the CPU 91 proceeds to step S302.

Further, in step S326, the CPU 91 expands the range of the threshold for the elapsed time from the printing date and time to the usage date and time. More specifically, the CPU 91 extends the range of the threshold referred to in step S314 to increase the frequency of a positive determination in step S314. Then, the CPU 91 proceeds to step S328.

Subsequently, in step S330, the CPU 91 acquires the attribute coefficient table 58. More specifically, the CPU 91 acquires the usage person attribute information table 56 from the ROM 93. Then, the CPU 91 proceeds to step S332.

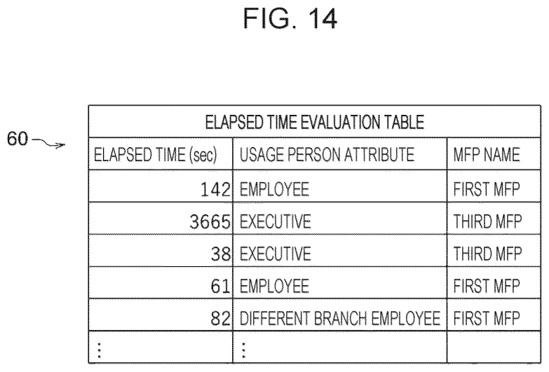

Subsequently, in step S332, the CPU 91 calculates a relevance evaluation table 62 for each attribute based on the elapsed time evaluation table 60 and the attribute coefficient table 58. More specifically, as illustrated in FIG. 15, the CPU 91 creates the relevance evaluation table 62 for each attribute based on the attribute and the coefficient listed in the attribute coefficient table 58 for the records included in the elapsed time evaluation time table created up to step S318. As illustrated in FIG. 15, in the relevance evaluation table 62, “MFP name” and “total score” indicating an evaluation result are recorded in combination for each attribute.

For example, FIG. 15 illustrates the process of calculation for a first record and a second record of the elapsed time evaluation table 60. In the first record, the attribute of the usage person is “employee” and the name of the MFP 18 is “first MFP”. In the first attribute table, the coefficient for the attribute “employee” is “1.00”, and therefore, in a first relevance evaluation table 62A, which is the relevance evaluation table 62 for an employee EE, 1.00 is added to the score for the “first MFP”. Furthermore, in the second attribute table, the coefficient for the attribute “employee” is “0.20”, and therefore, in a second relevance evaluation table 62B, which is the relevance evaluation table 62 for an executive MR, 0.20 is added to the score for the “first MFP”. Similarly, for the second record, 0.10 is added to the first relevance evaluation table 62A for the “third MFP”, and 1.00 is added to the second relevance evaluation table 62B for the “third MFP”.

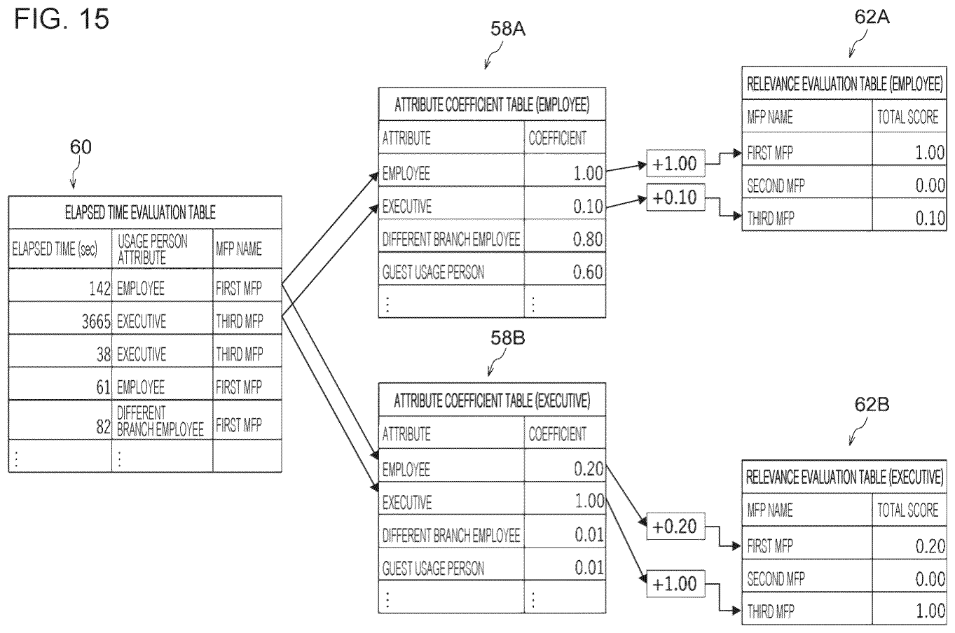

In this way, in step S332, the CPU 91 performs the above-described calculation for the records in the elapsed time evaluation table 60 and creates the relevance evaluation table 62 for each attribute, as illustrated in FIG. 16. Then, the CPU 91 proceeds to step S334.

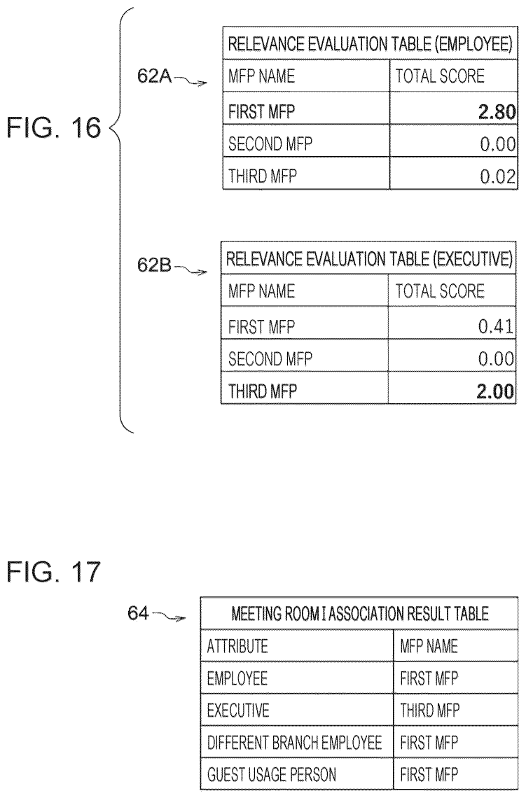

Subsequently, in step S334, the CPU 91 creates an association result table 64 in which the MFP 18 having the highest score in the relevance evaluation table 62 for each attribute is associated with the meeting room 32. More specifically, with regard to the relevance evaluation table 62 for each attribute calculated in step S332, the CPU 91 determines the name of the MFP 18 having the highest score, as indicated by boldface in FIG. 16. Then, as illustrated in FIG. 17, the CPU 91 inputs, for each attribute, the name of the MFP 18 having the highest score in the “MFP name” field of the association result table 64.

Furthermore, the CPU 91 records the association result table 64 created in step S334 as an example in the ROM 93. Then, the CPU 91 ends the procedure for associating the MFP 18 with the meeting room 32.

Through the procedure up to step S334 described above, the CPU 91 creates the association result table 64 and thus associates the MFP 18 with the meeting room 32 for each attribute. For example, FIG. 17 illustrates that the first meeting room 32A is associated with the first MFP 18A for the user UR having the attributes of “employee”, “different branch employee”, and “guest usage person”. Further, for example, FIG. 17 illustrates that the first meeting room 32A is associated with the third MFP 18C for the user UR having the attribute “executive”.

Furthermore, according to the present exemplary embodiment, as illustrated in FIG. 12, in the first attribute coefficient table 58A corresponding to “employee”, the attribute “executive” is set to have the smallest coefficient for the attribute “employee”. In other words, for the attribute “employee”, the attribute “executive” is set to have lower similarity than the attribute “different branch employee” or “guest usage person”. As a result, the MFP 18 easily used by the user UR having the attribute “employee” can be set as the MFP 18 easily used by the user UR having the attribute “different branch employee” or the user UR having the attribute “guest usage person”.

Furthermore, in the second attribute coefficient table 58B corresponding to “executive”, for the attribute “executive”, the coefficient for the attribute “employee” is set to be small to a certain extent, but is set to be larger than the coefficients for the attributes of outside people, such as “different branch employee” and “guest usage person”. As a result, from the viewpoint of security risk and the like, the MFP 18 not easily used by the user UR having the attribute “executive” can be set as the MFP 18 easily used by the user UR having the attribute “different branch employee” or the user UR having the attribute “guest usage person”. Similarly, the MFP 18 slightly easily used by the user UR having the attribute “executive” can be set as the MFP 18 easily used by the user UR having the attribute “employee”.

### 5. Procedure for Execution of Processing by MFP

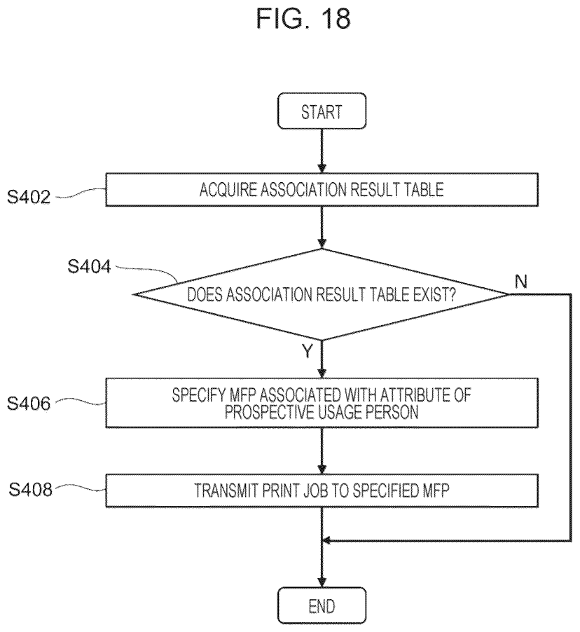

Next, a description will be given, with reference to FIG. 18, of a procedure for, in a case where the CPU 91 receives the document data PD from a usage person, causing an MFP associated with a meeting room to print the document data according to the present exemplary embodiment. In other words, the procedure in which the user UR prints the document data PD by the MFP 18 associated with the meeting room will be described.

(Procedure of Causing MFP Associated with Meeting Room to Print Document Data)

FIG. 18 illustrates a procedure in which the CPU 91 according to the present exemplary embodiment causes the MFP 18 to execute a print job based on the association result table 64 in a case where processing for executing printing by utilizing the MFP 18 is registered.

First, in step S402, the CPU 91 attempts to acquire the association result table 64. More specifically, the CPU 91 attempts to acquire the association result table 64 created in step S334 in the above-described procedure of associating the MFP 18 with the meeting room 32. Then, the CPU 91 proceeds to step S404.

Subsequently, in Step S404, the CPU 91 determines whether the association result table 64 exists. When the CPU 91 makes a positive determination in step S404, the process proceeds to step S406. Conversely, when the CPU 91 makes a negative determination in step S404, the procedure for causing the MFP 18 associated with the meeting room 32 to print the document data PD ends.

Subsequently, in step S406, the CPU 91 specifies the MFP 18 associated with the attribute of the prospective usage person. More specifically, when the CPU 91 receives the print job, the MFP 18 corresponding to the attribute of the user UR who has registered the print job and is expected to use the first meeting room 32A is specified by being acquired from the association result table 64. Then, the CPU 91 proceeds to step S408.

Subsequently, in step S408, the CPU 91 transmits the print job to the MFP 18 specified in step S406. In other words, by transmitting the print job to the MFP 18, the CPU 91 makes the MFP 18 available to the user UR who is expected to use the meeting room 32. Then, the CPU 91 ends the procedure for causing the MFP 18 associated with the meeting room 32 to print the document data PD.

Furthermore, in step S408, the CPU 91 may notify the MFP 18, to which the print job has been transmitted, to the prospective user UR. More specifically, the CPU 91 may notify the name of the MFP 18, to which the print job has been transmitted, to the portable device 36 of the prospective user UR and thus notify the MFP 18, to which the printed material PT is to be output, to the prospective user UR.

Thus, with the information output system 10 and the information processing system 12 described above according to the present exemplary embodiment, the following operations and effects can be obtained.

### Operation and Effect

The program according to the present exemplary embodiment causes the cloud server 14 to combine the usage date and time in the usage history data 54 when the user UR used the first meeting room 32A and the printing date and time when the user UR utilized the MFP 18 before the usage date and time in the usage history data 54. Then, the cloud server 14 is caused to associate the first meeting room 32A with the MFP 18 based on the combination and a predetermined determination criterion. Therefore, with the program according to the present exemplary embodiment, the first meeting room 32A and the associated MFP 18 can be associated with each other.

Further, the program according to the present exemplary embodiment causes the cloud server 14 to acquire the usage date and time in the usage history data 54 for the MFP 18 located within a predetermined range from the first meeting room 32A. Therefore, with the program according to the present exemplary embodiment, it is possible to reduce the risk of associating the MFP 18 having low relevance with the first meeting room 32A, as compared with a case where association is attempted for all the MFPs 18.

Further, the program according to the present exemplary embodiment acquires the file name FN from the record 49 together with the printing date and time and, when the file name FN satisfies a predetermined condition, causes the cloud server 14 to combine the usage date and time in the usage history data 54 and the printing date and time. For this reason, with the program according to the present exemplary embodiment, it is possible to suppress the risk of associating the MFP 18 having low relevance with the first meeting room 32A, as compared to a case where the association is performed based on the combination regardless of the file name FN included in the record 49.

Further, the program according to the present exemplary embodiment causes the cloud server 14 to execute the association when the number of combinations is equal to or more than a predetermined number. With the program according to the present exemplary embodiment, the influence of the record 49 that needs to be removed from association, for example, in the case of a normally unexpected utilization, can be relatively suppressed, as compared with the case where the association is executed even when the number of combinations is less than the predetermined number. Therefore, it is possible to suppress the risk of associating the first meeting room 32A with the MFP 18 having low relevance.

Furthermore, the program according to the present exemplary embodiment causes the cloud server 14 to associate the first meeting room 32A with the MFP 18 in a case where the elapsed time from the usage date and time in the usage history data 54 to the printing date and time in the combination falls within a predetermined time range. Then, with the program according to the present exemplary embodiment, the MFP that has a short time from the printing date and time to the usage date and time in the usage history data 54 and has higher relevance is preferentially associated. Therefore, as compared with a case where the association is executed regardless of the elapsed time, it is possible to reduce a risk of associating the first meeting room 32A with the MFP 18 having low relevance.

Further, the program according to the present exemplary embodiment causes the cloud server 14 to change the predetermined range of the elapsed time when the number of combinations is less than the predetermined number. Then, with the program according to the present exemplary embodiment, it is possible to suppress a situation in which the number of combinations is too small and the influence of the record 49 that needs to be removed from association cannot be relatively suppressed. Therefore, as compared with a case where the association is executed regardless of the number of combinations, it is possible to reduce a risk of associating the first meeting room 32A with the MFP 18 having low relevance.

Further, the program according to the present exemplary embodiment causes the cloud server 14 to determine the relevance between the first meeting room 32A and the MFP 18 based on the attribute of the user in the combination. With the program according to the present exemplary embodiment, in a case where the MFP 18 to be utilized is distinguished for each attribute of a user, it is possible to suppress the association between the user UR having one attribute and the MFP 18 that is mainly utilized by the user UR having another attribute. Therefore, as compared with a case where the association is executed regardless of the attribute of the user UR, it is possible to suppress the risk of associating the MFP 18 having low relevance with the first meeting room 32A.

Furthermore, the program according to the present exemplary embodiment causes the cloud server 14 to determine the MFP 18 that executes the print job based on the result obtained by the association when it is determined that the user UR who is expected to use the meeting room 32 has registered the document data PD. Therefore, the program according to the present exemplary embodiment allows the prospective user UR to utilize the MFP 18 associated with the first meeting room 32A even though the user UR does not know the MFP 18 associated with the first meeting room 32A.

Further, the information processing system 12 according to the present exemplary embodiment causes the cloud server 14 to combine the usage date and time in the usage history data 54 when the user UR used the meeting room 32 and the printing date and time when the user UR utilized the MFP 18 before the usage date and time in the usage history data 54. Then, the cloud server 14 is caused to associate the first meeting room 32A with the MFP 18 based on the combination and a predetermined determination criterion. Therefore, the information processing system 12 according to the present exemplary embodiment can associate the first meeting room 32A with the associated MFP 18.

### Modification

In the above description, the CPU 91 acquires the usage history data 54 for the MFP 18 located within the range of the predetermined distance from the meeting room 32 as the predetermined range, but the operation of the program according to the present exemplary embodiment is not limited thereto. For example, the target MFP 18 for which the CPU 91 acquires the usage history data 54 may be detected from the MFPs 18 connected to the same local network 40 based on the IP addresses, or the like, and the detected MFP 18 may be set as the target MFP.

Further, in the above description, the CPU 91 combines the printing date and time with the usage date and time of the meeting room 32 when it is considered that the file name FN in the usage history data 54 indicates the usage of the meeting room 32; however, the operation of the program according to the present exemplary embodiment is not limited to thereto. For example, the CPU 91 may combine the printing date and time immediately before the usage date and time of the meeting room 32 with the usage date and time of the meeting room 32 without considering the file name FN.

Furthermore, in the above description, although the CPU 91 creates the association result table 64 when the number of records in the elapsed time evaluation table 60 falls within the range of the predetermined number; however, the operation of the program according to the present exemplary embodiment is not limited thereto. For example, the CPU 91 may create the association result table 64 regardless of the number of records in the elapsed time evaluation table 60.

Further, in the above description, when the elapsed time from the printing date and time to the usage date and time of the meeting room 32 falls within the predetermined time range, the CPU 91 adds the record to the record of the elapsed time evaluation table 60; however, the operation of the program according to the present exemplary embodiment is not limited thereto. For example, the CPU 91 may combine the printing date and time immediately before the usage date and time of the meeting room 32 with the usage date and time of the meeting room 32 regardless of the elapsed time from the printing date and time to the usage date and time of the meeting room 32.

In the above description, when the number of records in the elapsed time evaluation table 60 is less than the predetermined number, the CPU 91 changes the range of the elapsed time from the printing date and time to the usage date and time of the meeting room 32; however, the operation of the program according to the present exemplary embodiment is not limited thereto. For example, even when the number of records in the elapsed time evaluation table 60 is less than the predetermined number, the CPU 91 may create the association result table 64 without changing the range of the elapsed time.

Furthermore, although in the description above, the CPU 91 uses the attribute coefficient table 58 to associate the meeting room 32 and the MFP 18 for each attribute of the usage person and create the association result table 64, the operation of the program according to the present exemplary embodiment is not limited thereto. For example, the CPU 91 may associate the meeting room 32 with the MFP 18 regardless of the attribute of the usage person.

In the above description, when the user UR who is expected to use the meeting room 32 transmits the document data PD to the cloud server 14, the print job is transmitted to the MFP 18 associated with the meeting room 32; however, the operation of the program according to the present exemplary embodiment is not limited thereto. For example, the CPU 91 may automatically notify the user UR who is expected to use the meeting room 32 of the MFP 18 associated with the meeting room 32, and the transmission of the print job may be executed when an input from the user UR is accepted.

Furthermore, although the CPU 91 associates the meeting room 32 with the MFP 18 and transmits the print job to the MFP 18 associated with the meeting room 32 in the description above, the information processing system 12 according to the present exemplary embodiment is not limited thereto. For example, different processors may associate the meeting room 32 with the MFP 18 and transmit the print job to the MFP 18 associated with the meeting room 32 based on the content of the association result table 64.

Even in these modifications, it is possible to obtain the same operation and effect as those described above.

While the exemplary embodiments of the present disclosure have been described with reference to the accompanying drawings, it is apparent that those skilled in the art to which the present disclosure pertains can conceive various modifications and applications within the scope of the technical idea described in the claims, and it is to be understood that they naturally belong to the technical scope of the present disclosure.

### APPENDIX

(((1)))

A program causing a computer to execute a process comprising associating a specific facility with an information device based on a combination of a usage period at which a usage person used the specific facility and a utilization period at which the usage person utilized the information device before the usage period and a predetermined determination criterion.

(((2)))

The program according to (((1))), wherein the process further comprises acquiring a utilization period at which the information device located within a predetermined range from the specific facility was utilized.

(((3)))

The program according to (((1))) or (((2))), wherein the process further comprises acquiring the utilization period from a utilization history of the information device together with identification information and combining the usage period and the utilization period when the identification information satisfies a predetermined condition.

(((4)))

The program according to any one of (((1))) to (((3))), wherein the associating is executed based on a predetermined number or more of the combinations.

(((5)))

The program according to (((4))), wherein the process further comprises combining the utilization period with the usage period when an elapsed time from the utilization period to the usage period falls within a predetermined time range.

(((6)))

The program according to (((5))), wherein the process further comprises changing the time range of the predetermined elapsed time when the number of the combinations combined is less than a predetermined number.

(((7)))

The program according to any one of (((4))) to (((6))), wherein the predetermined determination criterion includes a degree of relevance between the specific facility and the information device defined based on an attribute of the usage person in the combination.

(((8)))

A program causing a computer to execute a process comprising, when a prospective person who is expected to use the specific facility registers processing to be executed by utilizing any information device including the information device, determining the information device to execute the processing based on a result obtained by the associating according to any one of (((1))) to (((7))).

(((9)))

An information processing system comprising a processor configured to associate a specific facility with an information device based on a combination of a usage period at which a usage person used the specific facility and a utilization period at which the usage person utilized the information device before the usage period and a predetermined determination criterion.

(((10)))

An information processing method comprising associating a specific facility with an information device based on a combination of a usage period at which a usage person used the specific facility and a utilization period at which the usage person utilized the information device before the usage period and a predetermined determination criterion.

What is claimed is:

1. A non-transitory computer readable medium storing a program causing a computer to execute a process comprising:
associating a specific facility with an information device based on a combination of a usage period at which a usage person used the specific facility and a utilization period at which the usage person utilized the information device before the usage period and a predetermined determination criterion.

2. The non-transitory computer readable medium according to claim 1, wherein the process further comprises acquiring a utilization period at which the information device located within a predetermined range from the specific facility was utilized.

3. The non-transitory computer readable medium according to claim 1, wherein the process further comprises acquiring the utilization period from a utilization history of the information device together with identification information and combining the usage period and the utilization period when the identification information satisfies a predetermined condition.

4. The non-transitory computer readable medium according to claim 1, wherein the associating is executed based on a predetermined number or more of the combinations.

5. The non-transitory computer readable medium according to claim 4, wherein the process further comprises combining the utilization period with the usage period when an elapsed time from the utilization period to the usage period falls within a predetermined time range.

6. The non-transitory computer readable medium according to claim 5, wherein the process further comprises changing the time range of the predetermined elapsed time when the number of the combinations combined is less than a predetermined number.

7. The non-transitory computer readable medium according to claim 4, wherein the predetermined determination criterion includes a degree of relevance between the specific facility and the information device defined based on an attribute of the usage person in the combination.

8. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 1.

9. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 2.

10. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 3.

11. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 4.

12. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 5.

13. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 6.

14. A non-transitory computer readable medium storing a program causing a computer to execute a process comprising, when a prospective person who is expected to use the specific facility registers processing to be executed by utilizing any information device including the information device, determining the information device to execute the processing based on a result obtained by the associating according to claim 7.

15. An information processing system comprising:
a processor configured to associate a specific facility with an information device based on a combination of a usage period at which a usage person used the specific facility and a utilization period at which the usage person utilized the information device before the usage period and a predetermined determination criterion.

16. An information processing method comprising:
associating a specific facility with an information device based on a combination of a usage period at which a usage person used the specific facility and a utilization period at which the usage person utilized the information device before the usage period and a predetermined determination criterion.
